(19) United States
(12) Patent Application Publication
(10) Pub. No.: US 2026/0331749 A1
(43) Pub. Date: Oct. 22, 2026

(54) NONDESCRIPT ANTENNA SYSTEMS

(71) Applicant: Vorbeck Materials Corp., Columbia, MD (US)

(72) Inventor: Dan F. SCHEFFER, Frederick, MD (US)

(73) Assignee: Vorbeck Materials Corp., Columbia, MD (US)

(21) Appl. No.: 19/653,523

(22) Filed: Apr. 21, 2026

Related U.S. Application Data
(60) Provisional application No. 63/791,772, filed on Apr. 21, 2025.

(51) Int. Cl. H01Q 1/12; H01Q 1/20; H01Q 1/22

(52) U.S. Cl. CPC H01Q 1/1242; H01Q 1/20; H01Q 1/22

(57) ABSTRACT

Embodiments of the instant disclosure relate to nondescript antenna systems (“NDAS”) in the form of sign displays. In one embodiment, the NDAS includes a support panel, support structure, and connectivity junction. The connectivity junction is affixed to the support panel or the support structure and includes a radio frequency (“RF”) connector that selectively receives a communications device. The support panel includes an antenna element conductively coupled to the RF connector. The antenna element includes a conductive composition that includes a polymer matrix and fully exfoliated single sheets of graphene present in as a three-dimensional percolated network therein. The support panel is coupled to the support structure and combine to form a sign display. The support panel includes the antenna element, an RF insulating layer, and a RF reflective layer. The sign display is in the form of a flag and mast, A-frame stand, truss display, or a sign post display.

### CROSS-REFERENCE TO RELATED APPLICATIONS

This application claims the benefit of priority to U.S. Provisional Appl. 63/791,772, filed Apr. 21, 2025, and is a continuation-in-part of U.S. application Ser. No. 19/556,775, filed Mar. 4, 2026, the contents of which are incorporated by reference herein in their entirety.

### BACKGROUND

The instant disclosure relates generally to antenna systems and specifically to nondescript antenna systems. Nondescript antenna systems are designed with unconventional forms so they are not readily identifiable as antennas. Such antenna systems can offer several important advantages in applications where appearance, durability, and discretion matter alongside RF performance. Because they do not resemble traditional antennas, they can minimize visual impact and blend naturally into products, structures, or environments, supporting clean industrial and consumer design. Their lack of obvious antenna features may also reduce the risk of tampering, vandalism, or accidental damage, which is particularly valuable in public, industrial, or security-sensitive installations.

In concealment-focused use cases such as asset tracking, surveillance, or defense systems, nondescript antenna systems can lower detectability and make it more difficult for others to locate, disable, or interfere with the antenna. When integrated into an enclosure or structural element, they can benefit from added environmental protection against weather, contaminants, and mechanical stress, improving long-term reliability. Additionally, their unconventional forms provide greater flexibility in fitting antennas into constrained or irregular spaces, and because users are unlikely to recognize or handle them as antennas, performance is less affected by unintended blocking or detuning during normal use.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

A first aspect relates to nondescript antenna systems. In one embodiment, the nondescript antenna system includes at least one support panel, support structure, and connectivity junction. The connectivity junction is affixed proximate to either the support panel or the support structure as well as includes at least one radio frequency (“RF”) connector. Each RF connector selectively receives a communications device. The support panel includes at least one antenna element. Each antenna element is conductively coupled to one of said RF connectors. The antenna element includes a conductive composition that includes a polymer(s) and fully exfoliated single sheets of graphene. To maximize conductivity, the fully exfoliated single sheets of graphene are present in the polymer as a three-dimensional percolated network.

The support panel is selectively coupled to the support structure. The support panel and the support structure combine to form a sign display. In certain aspects, the support structure includes a coupling element(s) that selectively affixes the support panel to a surface. The support panel includes one or more first layers, second layers, third layers, and/or fourth layers. The first layer includes the antenna element(s). The second layer includes an electrically insulating material(s). The second layer is affixed to the first layer. The third layer is positioned proximate to the first layer and/or the second layer and has a Martindale score of at least 30,000. The fourth layer is positioned proximate to and between the second layer and the third layer and includes a material(s) that reflects electromagnetic (EM) radiation to thereby reflect EM radiation emanating from the antenna element(s).

In some aspects, the support panel is a flag and the support structure is selected from a group consisting of a flagpole, staff, flagstaff, or mast. In other aspects, the support structure includes a post, a sign mounting hardware, and/or a base component. The sign mounting hardware selectively couples the support panel to the support structure. The base component selectively couples the support structure to a surface. In certain aspects, the sign display is an A-frame stand structure. In yet still other aspects, the support structure includes at least one truss section and the sign display is a truss display.

### BRIEF DESCRIPTION OF THE DRAWINGS

Aspects of the present disclosure are illustrated by way of example and are not limited by the accompanying figures for which like references indicate like elements.

FIG. 1 is a block diagram illustrating a sign display, in accordance with some embodiments of the instant disclosure.

FIG. 2 depicts an exploded view of a support panel the sign display of FIG. 1, in accordance with other embodiments of the instant disclosure.

FIG. 3 depicts a perspective view of a sign display in the form of an A-frame stand, in accordance with certain embodiments of the instant disclosure.

FIG. 4 depicts a sign display in the form of a flag mounted on a flag post, in accordance with yet still other embodiments of the instant disclosure.

FIG. 5 depicts a sign display in the form of a truss display system, in accordance with some embodiments of the instant disclosure.

FIG. 6 depicts a sign display in the form of a sign mounted on a sign post display, in accordance with other embodiments of the instant disclosure.

### DETAILED DESCRIPTION

The descriptions of the various embodiments of the instant disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Certain terminology may be employed in the following description for convenience rather than for any limiting purpose. For example, the terms “forward” and “rearward,” “front” and “rear,” “right” and “left,” “upper” and “lower,” and “top” and “bottom” designate directions in the drawings to which reference is made, with the terms “inward,” “inner,” “interior,” or “inboard” and “outward,” “outer,” “exterior,” or “outboard” referring, respectively, to directions toward and away from the center of the referenced element, the terms “radial” or “horizontal” and “axial” or “vertical” referring, respectively, to directions or planes which are perpendicular, in the case of radial or horizontal, or parallel, in the case of axial or vertical, to the longitudinal central axis of the referenced element, the terms “proximate” and “distal” referring, respectively, to positions or locations that are close or away from a point of reference, and the terms “downstream” and “upstream” referring, respectively, to directions in and opposite that of fluid flow. Terminology of similar import other than the words specifically mentioned above likewise is to be considered as being used for purposes of convenience rather than in any limiting sense.

The terminology used herein is for the purpose of describing particular aspects only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In the figures, elements having an alphanumeric designation may be referenced herein collectively or in the alternative, as will be apparent from context, by the numeric portion of the designation only. Further, the constituent parts of various elements in the figures may be designated with separate reference numerals which shall be understood to refer to that constituent part of the element and not the element as a whole. General references, along with references to spaces, surfaces, dimensions, and extents, may be designated with arrows. Angles may be designated as “included” as measured relative to surfaces or axes of an element and as defining a space bounded internally within such element therebetween, or otherwise without such designation as being measured relative to surfaces or axes of an element and as defining a space bounded externally by or outside of such element therebetween. Generally, the measures of the angles stated are as determined relative to a common axis, which axis may be transposed in the figures for purposes of convenience in projecting the vertex of an angle defined between the axis and a surface which otherwise does not extend to the axis. The term “axis” may refer to a line or to a transverse plane through such line as will be apparent from context.

Nondescript antenna systems are designed with unconventional forms so they are not readily identifiable as antenna systems. Such antenna systems can offer several important advantages in applications where appearance, durability, and discretion matter alongside RF performance. Because they do not resemble traditional antennas, they can minimize visual impact and blend naturally into products, structures, or environments, supporting clean industrial and consumer design. Their lack of obvious antenna features may also reduce the risk of tampering, vandalism, or accidental damage, which is particularly valuable in public, industrial, or security-sensitive installations.

In concealment-focused use cases such as asset tracking, surveillance, or defense systems, nondescript antenna systems can lower detectability and make it more difficult for others to locate, disable, or interfere with the antenna. When integrated into an enclosure or structural element, they can benefit from added environmental protection against weather, contaminants, and mechanical stress, improving long-term reliability. Additionally, their unconventional forms provide greater flexibility in fitting antennas into constrained or irregular spaces, and because users are unlikely to recognize or handle them as antennas, performance is less affected by unintended blocking or detuning during normal use.

Embodiments of the instant disclosure seek to provide nondescript antenna systems in the form of sign displays. As used herein, a sign display is a structure used to visually convey information, messages, or advertisements to an audience. Other aspects of the instant disclosure seek to provide antennas and antenna arrays that are adhered to or embedded within nontraditional communications structures to generate nondescript fully functional antenna systems that are not readily identifiable as antenna systems.

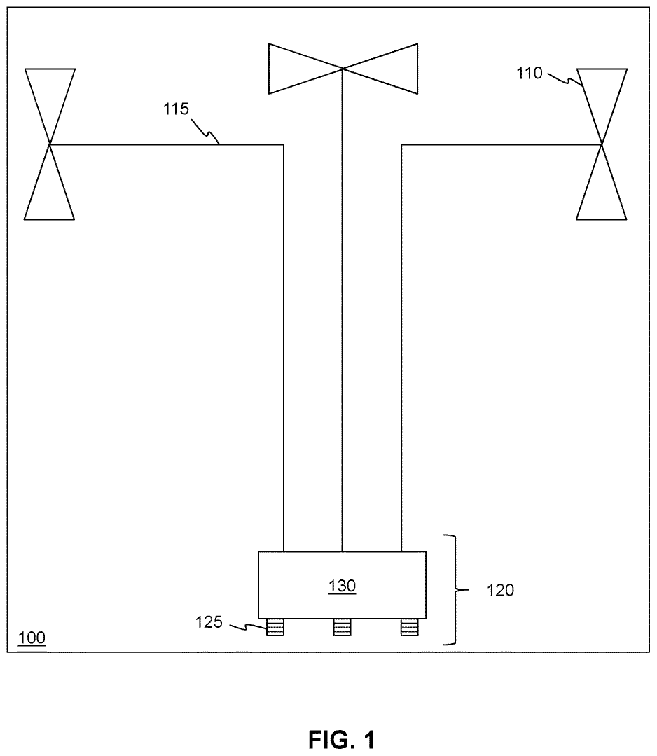

Turning now to the figures. FIG. 1 is a block diagram illustrating a sign display, generally 100, in accordance with some embodiments. Sign display 100 is a non-descript antenna system in the form of a physical medium or structure configured to visually present information, messages, or advertisements to an audience using text, symbols, images, and/or video. For example, sign display 100 can be a storefront sign, billboard, banner, poster, sandwich board (A-frame sign), wayfinding sign, flag, sign post, as well as similar structures and medium. Sign display 100 includes one or more antenna elements 110 and connectivity junction 120. In preferred embodiments, sign display 100 further include a support panel(s) and support structure(s) (discussed further below). For example, the support panel can be rotatably and/or selectively coupled to the support structure.

Connectivity junction 120 is preferably permanently or selectively attached to or embedded in a side of the support panel and serves as the radio connection hub (or bulkhead) that couples to one or more communications systems. In some embodiments, applicable communications systems can include, but are not limited to, handheld or portable radio systems known in the art such as, Persistent®, Silvus®, Rajant®, Single Channel Ground and Airborne Radio System (SINCGARS), etc. In other embodiments, the applicable communications systems are stationary or non-man portable. Connectivity junction 120 can be at least partially affixed to the support panel or the support structure. In some aspects, the support structure includes RF insulating material. Connectivity junction 120 preferably includes housing 130. Housing 130 is preferably formed using polymeric material, metals, alloys, and/or a combination of two or more thereof. Housing 130 can include one or more radio-frequency (RF) connectors 125, which are at least partially positioned therein. Each RF connector 125 selectively and conductively couples to a mobile communications system at a first end and is conductively coupled to at least one antenna element 110 at a second end via transmission line 115.

Antenna elements 110 can be terminated with metallic crimps (e.g., for fixed antennas) or selectable mechanical fasteners that allow the antenna element to be selectively affixed to a surface or object (e.g., for interchangeable antennas), which are subsequently coupled to a cable (e.g., transmission line 115). Applicable cables and connectors include, but are not limited to, coaxial cables (e.g., RG316 cable) and RF connectors (e.g., micro-miniature coaxial “MMCX” connector). In other embodiments, antenna elements 110 are singularly positioned and/or horizontally/vertically positioned in pairs of two to cover one or more different frequencies. As such, the operating frequencies of antenna elements 110 may vary to allow sign display 100 to operate as a multi-frequency system. Antenna element 110 can be an antenna array.

Antenna element 110 can be formed using a conductive composition. For example, antenna element 110 can be formed via printing (e.g., screen printing, heat transfer printing, etching, stencil, etc.), molding, casting, extrusion, and/or similar manufacturing techniques known in the art. Alternatively, antenna element 110 can be pre-formed via molding, casting, additive manufacturing, and/or extrusion and subsequently affixed (e.g., via bonding) to a surface (e.g., layer 201). Antenna element 110 can be printed on substrates (e.g., layer 201) having melting points of up to at least 300° F. to about 800° F. (e.g., thermoplastic polymers, polyethylene terephthalate, Kevlar, nylons, polyesters, metal-coated materials, materials that are scorch/heat resistant, as well as similar materials). Such high melting points allow the substrates to withstand elevated temperatures that are necessary to cure the conductive compositions.

In some aspects, subsequent to printing, curing and/or crimping (i.e., formation), antenna element 110 is fully encapsulated individually in between two layers of waterproof fabric (e.g., water-proof ballistic nylon fabrics, ripstop nylons, 50/50 Nylon/Cotton blends) using a polymeric adhesive layer (e.g., a thermoplastic polyurethane (“PTU”) film). The printed antenna elements can be terminated with (i.e., conductively coupled to) (i) metal crimps to fabricate fixed antennas or (ii) snap fasteners (or snap-fit fasteners) to fabricate interchangeable antennas elements. Adhesive layers preferably have a thickness between 1-4 millimeters. Other materials, such as polyvinyl chloride (“PVC”) based films, can also be used for encapsulation. In preferred embodiments, the substrate has a thickness of about 0.1 to 0.5 inches and the conductive compositions are printed to a deposition thickness of about 30 μm to 75 μm. The size and shape of the antenna elements are dependent on its operational frequency.

Antenna element 110 is preferably flexible and suitable for folding, low profile and nondescript solutions. Antenna element 110 can have a radius of curvature of 10 mm or less. In other embodiments, antenna element 110 can have a radius of curvature of 1 mm or less. To generate nondescript antenna systems one or more individual antenna elements can be covered with a nonfunctional fabric or material to convey a nondescript overall structure. Antenna element 110 is preferably a planar, flexible, polymeric structure.

The conductive composition includes a polymer(s) and fully exfoliated single sheets of graphene. To maximize conductivity, the fully exfoliated single sheets of graphene are present in the polymer as a three-dimensional percolated network. Applicable polymers are electrically conductive (e.g., polyacetylene, polyethylene dioxythiophene, polyaniline, polypyrrole, other electrically conductive polymers, or a combination of two or more thereof. The conductive composition can include polymeric binders. Polymeric binders can be thermoplastics or thermosets and may be elastomers. Binders may also comprise monomers that can be polymerized before, during, or after the application of the ink to the substrate. Polymeric binders may be cross-linked or otherwise cured after the ink has been applied to the substrate.

Examples of preferred polymeric binders include, but are not limited to, polyethers such as poly(ethylene oxide) s (also known as poly(ethylene glycol) s, poly(propylene oxide) s (also known as poly(propylene glycol) s, ethylene oxide/propylene oxide copolymers, cellulosic resins (such as ethyl cellulose, ethyl hydroxyethyl cellulose, carboxymethyl cellulose, cellulose acetate, cellulose acetate propionates, and cellulose acetate butyrates), and poly(vinyl butyral), polyvinyl alcohol and its derivatives, ethylene/vinyl acetate polymers, acrylic polymers and copolymers, styrene/acrylic copolymers, styrene/maleic anhydride copolymers, isobutylene/maleic anhydride copolymers, vinyl acetate/ethylene copolymers, ethylene/acrylic acid copolymers, polyolefins, polystyrenes, olefin and styrene copolymers, epoxy resins, acrylic latex polymers, polyester acrylate oligomers and polymers, polyester diol diacrylate polymers, UV-curable resins, and polyamide, including polyamide polymers and copolymers (i.e., polyamides having at least two different repeat units) having melting points between about 120° C. and 255° C.

As used herein, the term “graphene sheets” refers to single sheets of hexagonally arranged carbon atoms that are approximately 1 nm or less thick and have a “platy” (e.g., two-dimensional) honeycomb lattice nanostructure. To be sure, graphene is electrically, mechanically, structurally and chemically unique compared to both graphite (a multi-layered structure) and carbon nanotubes (a hollow cylindrical structure). For example, graphene is a zero-gap semiconductor that exhibits the anomalous Quantum Hall Effect while carbon nanotubes, depending on their structure, can be either semiconducting, with a variable bandgap, or metallic.

However, in other embodiments, the conductive composition can contain a metal component(s) (e.g., silver, copper, gold, nickel, other metals, alloys, or a combination of two or more thereof). The conductive composition can be formed using various curing agents, curing temperatures, and/or curing times. For example, antennas element 110 can be formed to have an overall thickness of 0.100 to 0.25 inches. The conductive composition can have a deposition thickness of 35-75 μm. The size and shape of antenna element 110 can be determined based on the desired operational frequency of the antenna system.

To decrease the overall dimension of a low frequency antenna, a matching circuit may be required. In yet still other embodiments, antenna element 110 can be formed using hybrid conductive compositions (e.g., having a metal and graphene) or non-metallic conductive compositions. For example, when a hybrid conductive composition is used, the conductivity of antenna elements is preferably less than 0.060 □/sq. The conductivity of antenna elements fabricated using a non-metallic conductive composition is preferably less than 3.0 □/sq. For example, the conductivity values for the silver-based ink are preferably less than 0.020 □/sq. The conductivity values for the graphene-based ink are less than 2.0 □/sq. Alternatively, the antenna elements can be completely formed using a conductive composition that is void of silver or other metals and strictly includes graphene as its conductive medium.

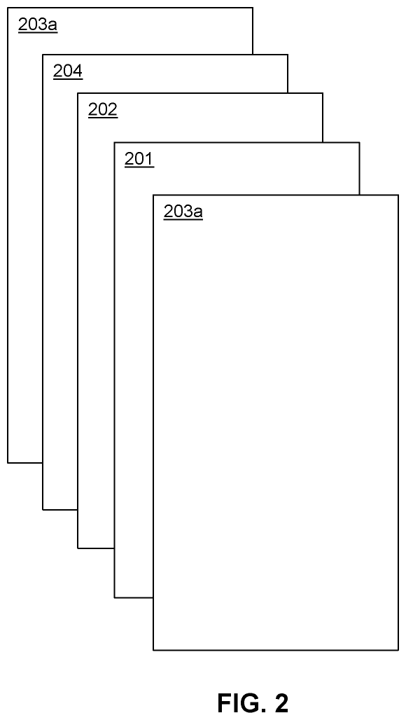

FIG. 2 is an exploded view of a support panel, generally 200, in accordance with certain embodiments of the instant disclosure. Support panel 200 can be configured to be a rigid, foldable, and/or bendable structure to enable one or more embodiments discussed herein. For example, support panel 200 can have a radius of curvature of 10 mm or less. In other embodiments, support panel 200 has a radius of curvature of 1 mm or less. Waterproof/water repellent and/or flame-retardant aqueous solutions (e.g., polymer-based solutions that include silicone, polyurethane, and similar polymers) can be applied to the exterior surface of support panel 200 to provide additional environmental protection. Support panel 100 is preferably a multilayered structure that includes a plurality of layers affixed together.

Support panel 200 can include at least one first layer 201, second layer 202, third layer 203, and/or fourth layer 204. First layer 201 preferably includes at least one antenna element 110. From an RF communications perspective, support panels that both reflect electromagnetic (EM) radiation and provide RF insulation (i.e., block transmission through the surface) are valuable because they both direct RF energy where needed and prevent it from propagating where it is not. Second layer 202 can be an RF insulating layer that includes insulating material. To reduce RF signal interference, antenna element 110 of first layer 201 can be positioned on an insulating layer (e.g., second layer 202) that has a frequency-dependent thicknesses.

For example, second layer 202 can include a graphene-based polymeric coating or other RF insulating coating. In some aspects, second layer 202 can include, but are not limited to, closed cell foam materials (e.g., polyethylene foam, Neoprene foam, silicone foam (high temperature resistant)) as well as RF insulating boards (e.g., extruded polystyrene board). An example of the frequency-based thickness of second layer 202 is reflected in Table 1 below:

TABLE 1

| | |
|---|---|
| Frequency | Thickness |

| | | |
|---|---|---|
| 5.8 | GHz | ⅛″ |
| 2.4 | GHz | ¼″ |
| 900 | MHz | ½″ |
| 400 | MHz | 1.5-2″ |

| | |
|---|---|
| <100 MHz or less | ≥5″ |

Support panel 200 can have one or more external protective layers. For example, third layers 203a, 203b can be external protective layers (e.g., to protect against moisture, physical impacts, collisions, and/or abrasions, etc.) and/or structural support layers (e.g., a structural panel formed using a polymer, a metal, and/or cellulose-based material). For example, third layer 203 can be an outer layer that protects against environmental events (e.g., water, impacts, collisions, and/or abrasions, etc.). Fourth layer 204 is configured to reflect electromagnetic (EM) radiation emanating from antenna element 110. In certain embodiments, fourth layer 204 is formed (e.g., via printing, casting, and/or molding) using a version of the conductive composition (or other conductive coating/material) that has a higher resistivity value compared to that of antenna element 110. Fourth layer 104 can include an EM reflecting material.

For example, third layer 203 can be a polymeric fabric layer that includes, but is not limited to, ultra-high-molecular-weight polyethylene, high density polyethylene, Kevlar, nylon, and/or acetal. In general, third layer 203 can be affixed to one or more sides of support panel 200. In other embodiments, third layer 203 can include a textile that has a Martindale fabric abrasion test score of at least 30,000 or 40,000 or 50,000. In some embodiments, third layer 203 is positioned proximate to first layer 101 and/or second layer 202. In certain embodiments, fourth layer 104 is positioned proximate to and between second layer 202 and third layer 203a. Although not shown, support panel 200 can include any number and/or combination of layers disclosed herein to enable an embodiment of the present disclosure.

In other embodiments, support panel 200 is asymmetrically layered. Here, an insulating layer (e.g., second layer 202) is positioned on an EMI shielding layer (e.g., fourth layer 204). A print substrate (e.g., first layer 201) is positioned on the insulating layer. Antenna element(s) 110 are printed on the print substrate. An encapsulating layer (e.g., third layer 203b) is positioned on the antenna elements. Lastly, a nondescript layer is positioned on or included in the encapsulating layer. The asymmetric configuration can be incorporated on to the exterior side of aerial housings (e.g., helium balloon baskets, unmanned aerial vehicles) or on the underside thereof (e.g., which promotes connectivity and communications with and between nodes, such as drones and ground personnel). Here, the nondescript antenna system can be positioned in the aerial housing to provide and/or reinforce communications links between the ground station and an RF source. In yet still other embodiments, support panel 200 is symmetrically layered where each set of layers are positioned on the same EMI shielding layer. The symmetrical configuration results in an antenna system that can have at least two unique operating frequencies.

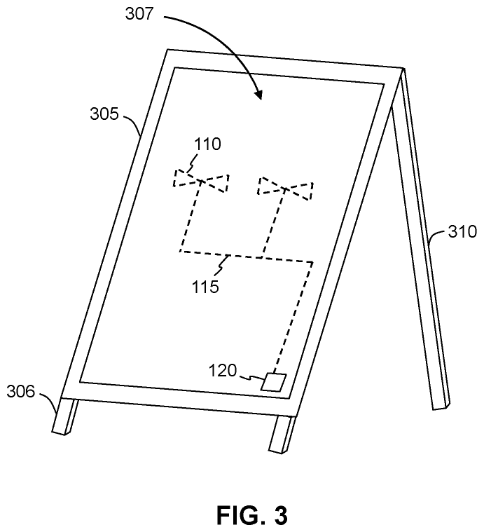

FIG. 3 depicts a perspective view of a sign display, generally 300, in accordance yet still other embodiments of the instant disclosure. Sign display 300 is a non-descript antenna system that can include one or more features, components, and/or functionalities of sign display 100. Sign display 300 can be an A-frame display that can include support panel 305 coupled (e.g., hinge coupled) to support structure 310. Support panel 305 includes at least one embedded or surface mounted antenna element 110 communicatively coupled to connectivity junction 120. Here, support panel 305 can be formed using wood, cellulose-based materials, polymeric materials, metal, or a combination of two or more thereof. Here, support panel 305 can include main body 307 (see panel portion) supported by support appendages 306 that rest against the ground during use. Support structure 310 can include a main body and/or support appendages. Alternatively, connectivity junction 120 can included in support structure 310. In preferred embodiments, antenna element 110 and connectivity junction 120 are at least partially embedded in support panel 305 and/or support structure 310.

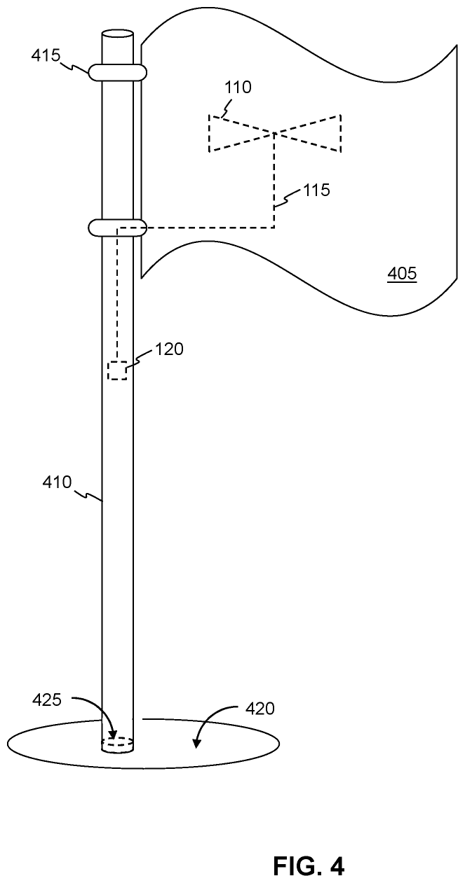

FIG. 4 depicts a sign display, generally 400, in accordance with some embodiments of the instant disclosure. Sign display 400 is a non-descript antenna system that can include one or more features, components, and/or functionalities of sign display 100. Sign display 400 can be a flag display structure that can facilitate RF communications. In general, sign display 400 can include one or more features and/or components of sign display 100 discussed above. Sign display 400 may include support panel 405 selectively and/or mechanically coupled, via at least one mechanical coupler 415, to support structure 410 in a manner that allows support panel 405 to hang and, in many cases, move freely in the wind. Support panel 405 can be a textile-based structure formed to resemble a flag and at least partially have a radius of curvature of 10 mm or less (i.e., have a structure that is bendable and/or foldable).

Support panel 405 can have an overall structure that is ovular, circular, rectangular, square, or any geometric shape that enables an embodiment of the instant disclosure. Support structure 410 can be a staff, pole, mast, or similar structure configured to support, hoist, and/or display support panel 405. Support structure 410 can be formed using wood, cellulose-based materials, polymeric materials, metals, alloys, or a combination of two or more thereof. Support structure 410 can be configured to be free-standing (e.g., include a support base that can be placed on a surface and thereby position support structure 410 in a manner to present support panel 405) or attached to a surface (e.g., building, bridge, monument, or any applicable surface). In some embodiments, at least one antenna element 110 is affixed to or embedded within support panel 405 and conductively coupled, via transmission line 115 to connectivity junction 120, which is affixed to or embedded within support structure 410. In certain embodiments, transmission line 115 traverses support panel 405 through mechanical coupler 415 and support structure 410 to terminate at connectivity junction 120.

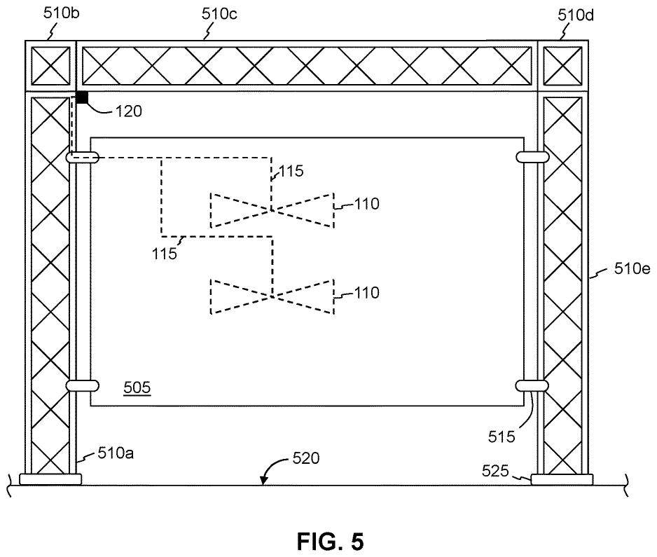

FIG. 5 depicts a sign display, generally 500, in accordance with other embodiments of the instant disclosure. Sign display 500 is a non-descript antenna system that can include one or more features, components, and/or functionalities of sign display 100. Sign display 500 can be a truss display that facilitates RF communications. For example, sign display 500 can be an assembly of truss members (e.g., support structure 510) (e.g., connected by nodes) that create a rigid structure. In certain embodiments, sign display 500 can be assembled and installed using one or more structural truss screws, hurricane ties, metal connector plates (nail plates), and/or specialized bolts. Sign display 500 can include at least one support structure 510, which is preferably a truss section (e.g., a Pratt truss, Warren truss, Fink truss, or other truss section known in the art). Support structure 510 can be mechanically coupled to support panel 505 via one or more mechanical couplers 515. Although sign display 500 is depicted as having multiple support structures 510, any number of support structure 510 can be included. Support panel 505 can include at least antenna element 110 conductive coupled to connectivity junction 120. In certain embodiments, support panel 505 has a radius of curvature of 10 mm or less. Alternatively, support panel 505 at least partially has structural rigidity. Here, connectivity junction 120 can be included affixed to or embedded in support structure 510 or support panel 505.

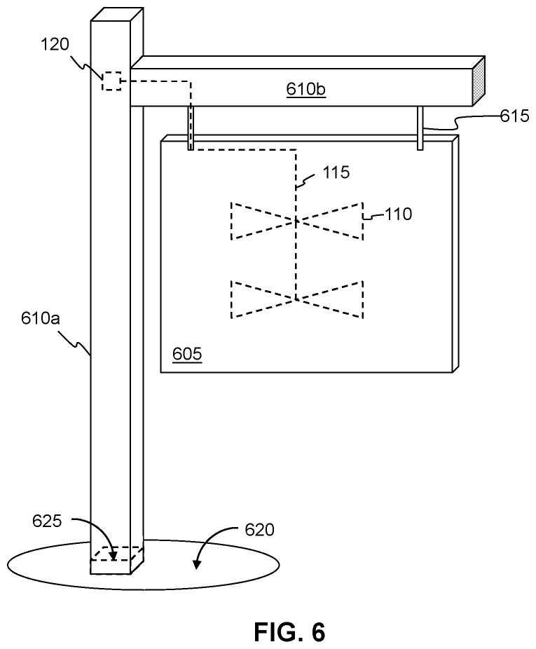

FIG. 6 depicts a sign display, generally 600, in accordance with yet still other embodiments of the instant disclosure. Sign display 600 is a sign post display that can facilitate RF communications. In general, sign display 600 is a non-descript antenna system that can include one or more features, functionalities, and/or components of sign display 100 discussed above. As used herein, a “sign post display” refers to a vertical, ground-installed, or portable stand used to hold signs (e.g., panels, boards, or fingers) for displaying information, directions, or advertising to passersby. Sign display 600 can be made of metals, alloys, polymeric materials, cellulose-based materials, or a combination of two or more thereof. Sign display 600 can include support structure 610 coupled to support panel 605 via at least one mechanical coupler 615. Sign display 600 can have any number of mechanical couplers 615 to (selectively or permanently) secure support panel 605 to support structure 610. Support structure 610 is preferably a sign post (e.g., a U-channel post, a square tube, a round post, a steel post, a H-stand, or similar mounting posts).

Support structure 610 can be anchored in the ground or to a surface using anchoring components, a breakaway component, a post driver, or similar components. Mechanical coupler 615 can include tamper-resistant hardware (e.g., nuts and bolts), brackets, clamps, and/or fasteners. Support panel 605 and/or support structure 610 can include at least one antenna element 110. As shown, when support panel 605 includes antenna element 110, transmission line 115 can internally traverse mechanical coupler 615 and support structure 610 to terminate at connectivity junction 120.

Asymmetric antenna systems can be incorporated on to the exterior side of aerial housing (e.g., helium balloon baskets) or on the underside thereof (e.g., which promotes connectivity and communications with and between nodes, such as drones and ground personnel). Here, the communications device is positioned in the housing to provide and/or reinforce communications links between the ground station and the military/communication satellites.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A nondescript antenna system, comprising:
a support panel;
a support structure;
a connectivity junction;
wherein
the connectivity junction
is affixed proximate to the support panel or the support structure;
comprises a radio frequency (“RF”) connector;
the support panel comprises an antenna element;
the RF connector selectively receives a communications device;
the antenna element is conductively coupled the RF connector;
the support panel is selectively coupled to the support structure; and
the support panel and the support structure combine to form a sign display.

2. The nondescript antenna system of claim 1, wherein
the antenna element comprises a conductive composition;
the conductive composition comprises:
a polymer;
fully exfoliated single sheets of graphene; and
the fully exfoliated single sheets of graphene are present in the polymer as a three-dimensional percolated network.

3. The nondescript antenna system of claim 1, wherein
the support panel comprises:
a first layer;
a second layer affixed to the first layer;
the first layer comprises the antenna element; and
the second layer comprises an electrically insulating material.

4. The nondescript antenna system of claim 3, wherein
the support panel comprises a third layer;
the third layer
is positioned proximate to one or more of the first layer and the second layer; and
the third layer comprises a Martindale score of at least 30,000.

5. The nondescript antenna system of claim 4, wherein
the support panel comprises a fourth layer;
the fourth layer
is positioned proximate to and between the second layer and the third layer;
comprises a material that reflects electromagnetic (EM) radiation; and
reflects EM radiation emanating from the antenna element.

6. The nondescript antenna system of claim 1, wherein
the support panel is a flag; and
the support structure is selected from a group consisting of a flagpole, a staff, a flagstaff, or a mast.

7. The nondescript antenna system of claim 1, wherein
the support structure comprises one or more of a post, sign mounting hardware, and a base component;
the sign mounting hardware selectively couples the support panel to the support structure; and
the base component selectively couples the support structure to a surface.

8. The nondescript antenna system of claim 1, wherein
the sign display is an A-frame stand.

9. The nondescript antenna system of claim 1, wherein
the support structure comprises at least one truss section; and
the sign display is a truss display.

10. The nondescript antenna system of claim 1, wherein
the support structure comprises a coupling element that selectively affixes the support panel to a surface.
